(19) United States
(12) Patent Application Publication
(10) Pub. No.: US 2025/0210692 A1
(43) Pub. Date: Jun. 26, 2025

(54) Inorganic Glass Composite Solid Electrolytes for Lithium or Sodium Batteries

(71) Applicant: Massachusetts Institute of Technology, Cambridge, MA (US)

(72) Inventors: Ju Li, Weston, MA (US); Tao Dai, Somerville, MA (US)

(73) Assignee: Massachusetts Institute of Technology, Cambridge, MA (US)

(21) Appl. No.: 18/918,589

(22) Filed: Oct. 17, 2024

Related U.S. Application Data
(60) Provisional application No. 63/665,449, filed on Jun. 28, 2024.
(60) Provisional application No. 63/614,067, filed on Dec. 22, 2023.

(51) Int. Cl. H01M 10/0562; H01M 10/0525; H01M 10/054

(52) U.S. Cl. CPC H01M 10/0562; H01M 10/0525; H01M 10/054; H01M 2300/008; H01M 2300/0091

(57) ABSTRACT

Described herein is an inorganic glass composite solid electrolyte, comprising one or more solid electrolytes with the chemical formula: MₓAlE_{y}G_{z}Jₘ, wherein M denotes Li or Na, E denotes one or more elements selected from the group consisting of boron (B), phosphorus (P), silicon (Si), lanthanum (La), or cerium (Ce), G denotes at least one chalcogen element, Jdenotes at least one halide element, and the following mathematical formula is satisfied: 0<x<5, 0≤y<5, 0<z<5, m=x+ny−2z+3, wherein n=3 when E denotes at least one element selected from the group consisting of La, Ce and B; n=4 when E denotes Si; and n=5 when E denotes P. In embodiments, the inorganic glass composite solid electrolyte comprises one or more salts selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na.

### CROSS REFERENCE TO RELATED APPLICATIONS

This application claims the benefit under 35 U.S.C. § 119 of U.S. Provisional Patent Application No. 63/614,067 filed on Dec. 22, 2023, and U.S. Provisional Patent Application No. 63/665,449 filed on Jun. 28, 2024, which are hereby incorporated by reference herein in their entirety.

### STATEMENT REGARDING FEDERALLY SPONSORED RESEARCH

N/A

### BACKGROUND

Glass can occupy an amorphous state, meaning a non-crystalline state or semicrystalline state with amorphous regions. In an amorphous state, glass will transit from a hard and relatively brittle state, which can be referred to as a glassy state, into a viscous or rubbery state when the temperature is higher or close to the glass transition temperature (T_{g}). Accordingly, glass occupies a metastable state, and theoretically, will undergo an aging processes. During the aging process, the internal disordered structure will gradually become ordered, and the degree of vitrification will continue to decrease. Further, when the ambient temperature is higher than the T_{g}, the aging process will accelerate. Glass in a viscous or rubbery state can be highly deformable, which is useful in a number of different applications.

### SUMMARY OF DISCLOSED EMBODIMENTS

In one aspect, the present disclosure is directed towards an inorganic glass composite solid electrolyte, comprising: one or more solid electrolytes, wherein the solid electrolyte has the chemical formula: MₓAlE_{y}G_{z}Jₘ. In embodiments, M denotes Li or Na. In embodiments, E denotes one or more elements selected from the group consisting of boron (B), phosphorus (P), silicon (Si), lanthanum (La), or cerium (Ce). In embodiments, G denotes at least one chalcogen element. In embodiments, J denotes at least one halide element. In embodiments, the following mathematical formula is satisfied: 0<x<5, 0 [symbol] y<5, 0<z<5, m=x+ny−2z+3, wherein n=3 when E denotes at least one element selected from the group consisting of La, Ce and B; n=4 when E denotes Si; and n=5 when E denotes P. In embodiments, the inorganic glass composite solid electrolyte comprises one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5.

In embodiments, E is one element selected from the group consisting of B, P, Si, La, or Ce. In embodiments, the chalcogen element comprises one of: oxygen (O); sulfur (S); or selenium (Se). In embodiments, the halide element comprises one of: fluorine (F); chlorine (Cl); bromine (Br); or iodine (I). In embodiments, E is B, P, or Si and the following mathematical formula is satisfied: 0<y<5. In embodiments, E is La or Ce and the following mathematical formula is satisfied: 0<y<5 and m=x+3y−2z+3. In embodiments, G denotes oxygen (O). In embodiments, E is P, G is O, J is Cl, and the following mathematical formula is satisfied: 0<y<5 and m=x+5y−2z+3. In embodiments, the one or more salts is MN(SO₂F)₂.

According to another aspect, the present disclosure is directed towards a battery, comprising: a positive electrode; and, an electrolyte layer disposed on the positive electrode. The electrolyte layer comprises an inorganic glass composite solid electrolyte, comprising one or more solid electrolytes. In embodiments, the solid electrolyte has the chemical formula: MₓAlE_{y}G_{z}Jₘ, wherein M denotes Li or Na, E denotes one or more elements selected from the group consisting of boron (B), phosphorus (P), silicon (Si), lanthanum (La), or cerium (Ce), G denotes at least one chalcogen element, J denotes at least one halide element, and the following mathematical formula is satisfied: 0<x<5, 0 [symbol] y<5, 0<z<5, m=x+ny−2z+3, wherein n=3 when E denotes at least one element selected from the group consisting of La, Ce and B; n=4 when E denotes Si; and n=5 when E denotes P. In embodiments, the solid electrolyte comprises one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5. In embodiments, the battery comprises a negative electrode disposed on the electrolyte layer.

In embodiments, E is one element selected from the group consisting of B, P, Si, La, or Ce. In embodiments, G denotes oxygen (O). In embodiments, E is P, G is O, J is Cl, and the following mathematical formula is satisfied: 0<y<5 and m=x+5y−2z+3. In embodiments, the one or more salts is MN(SO₂F)₂. In embodiments, the chalcogen element comprises one of: oxygen (O); sulfur (S); or selenium (Se). In embodiments, the halide element comprises one of: fluorine (F); chlorine (Cl); bromine (Br); or iodine (I).

According to another aspect, the present disclosure is directed towards a method for forming a battery, comprising: providing a positive electrode, and disposing an electrolyte layer on the positive electrode. The electrolyte layer comprises an inorganic glass composite solid electrolyte, comprising: one or more solid electrolytes. In embodiments, the solid electrolyte has the chemical formula: MₓAlE_{y}G_{z}Jₘ, wherein M denotes Li or Na, E denotes one or more elements selected from the group consisting of boron (B), phosphorus (P), silicon (Si), lanthanum (La), or cerium (Ce), G denotes at least one chalcogen element, J denotes at least one halide element, and the following mathematical formula is satisfied: 0<x<5, 0 [symbol] y<5, 0<z<5, m=x+ny−2z+3, wherein n=3 when E denotes at least one element selected from the group consisting of La, Ce and B; n=4 when E denotes Si; and n=5 when E denotes P. In embodiments, the inorganic glass composite solid electrolyte comprises one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5. In embodiments, the method comprises rolling the electrolyte layer to a desired thickness by utilizing a hot forming process. In embodiments, the method comprises disposing a negative electrode on the electrolyte layer.

In embodiments, rolling the electrolyte layer is carried out with a roller. In embodiments, a glass transition temperature (T_{g}) of the electrolyte layer is less than room temperature. In embodiments, E is one element selected from the group consisting of B, P, Si, La, or Ce.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is a top view of an inorganic glass composite solid electrolyte;

FIG. 1B is an exemplary schematic of a electrochemical cell, including an inorganic glass composite solid electrolyte, such as the inorganic glass composite solid electrolyte of FIG. 1A;

FIG. 1C is a block diagram of a method to form an electrochemical cell, such as the electrochemical cell in FIG. 1B;

FIG. 2A is a graph of several linear sweep voltammetry (LSV) tests, illustrating reduction potential for various electrolytes, including an inorganic glass composite solid electrolyte;

FIG. 2B is a graph of Log 10 (σ, S/cm) vs. 1000/T (1/K) and temperature (° C.), illustrating ionic conductivity for various electrolytes, including an inorganic glass composite solid electrolyte;

FIG. 3A is a graph of temperature (C) vs. modulus (MPa) and loss factor Tan δ, illustrating mechanical performance for an inorganic glass composite solid electrolyte;

FIG. 3B is a graph of stress (MPa) vs. strain (%), illustrating mechanical performance for an inorganic glass composite solid electrolyte;

FIG. 3C is a graph of creep strain (%) vs. holding time (min), illustrating mechanical performance for an inorganic glass composite solid electrolyte;

FIG. 4 is a graph of cycling profiles for two cells, illustrating the cycling results for various electrolytes, including an inorganic glass composite solid electrolyte;

FIG. 5A is a graph of intensity (a.u.) vs. binding energy (eV), illustrating a Al 2p signal in cycled LACO75;

FIG. 5B is a graph of intensity (a.u.) vs. binding energy (eV), illustrating a Al 2p signal in cycled LACO75−15FSI;

FIG. 6A is a graph of voltage (V) vs. specific capacity (mAh g⁻¹) for a Li/LACO75−15FSI/LACO−NCM622 cell; and

FIG. 6B is a graph of cycle number vs. specific capacity (mAh g⁻¹) and columbic efficiency (%) for a Li/LACO75−15FSI/LACO−NCM622 cell.

### DETAILED DESCRIPTION

Before describing the broad concepts, devices, systems, and techniques sought to be protected herein, some introductory concepts are explained. One kind of conventional glass electrolyte is MACO, where M stands for lithium (Li) or sodium (Na), A stands for aluminum (Al), C stands for chlorine (Cl), and O stands for oxygen (O). Accordingly, LACO refers to an embodiment where L stands for lithium (Li), A stands for aluminum (Al), C stands for chlorine (Cl), and O stands for oxygen (O).

Conventional MACO glass electrolytes demonstrate mechanical deformability at about room temperature (25° C.+/−2° C.). This results from the glass transition temperature (T_{g}) of MACO, which is lower than room temperature. However, the reduction potentials of MACO are 1.45 V vs. Li/Li⁺ (for a MACO electrolyte where M stands for Li) and 1.55 V vs. Na/Na⁺ (for a MACO electrolyte where M stands for Na). Accordingly, MACO electrolytes are not stable with an anode that has a redox potential lower than 1.45 V (for a MACO electrolyte where M stands for Li) and 1.55 V (for a MACO electrolyte where M stands for Na), let alone with lithium or sodium metal anodes.

Concepts described herein are directed towards enhancing the compatibility of LACO with Li metal or Na metal by adding in one or more salts. Accordingly, disclosed herein is an inorganic glass composite solid electrolyte comprising solid electrolytes and one or more salts. The disclosed inorganic glass composite solid electrolyte demonstrates notable electrochemical stability with an Li or Na anode.

The inorganic glass composite solid electrolyte includes one or more solid electrolytes, where the solid electrolyte has the chemical formula: MₓAlE_{y}G_{z}Jₘ, where M denotes Li or Na, E denotes one or more elements selected from the group consisting of boron (B), phosphorus (P), silicon (Si), lanthanum (La), or cerium (Ce), G denotes at least one chalcogen element, J denotes at least one halide element, and the following mathematical formula is satisfied: 0<x<5, 0 [symbol] y<5, 0<z<5, m=x+ny−2z+3, where n=3 when E denotes at least one element selected from the group consisting of La, Ce and B; n=4 when E denotes Si; and n=5 when E denotes P. The inorganic glass composite solid electrolyte includes one or more salts. The salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, where M is Li or Na, and where the mass ratio of the salt to the solid electrolyte is r_{w}, where 0<r_{w}<5. In an embodiment where y=0, there is no E, accordingly the center element is Al.

In embodiments, E is one element selected from the group consisting of B, P, Si, La, or Ce. In embodiments, E is B, P, or Si and the following mathematical formula is satisfied: 0<y<5. In embodiments, E is La or Ce and the following mathematical formula is satisfied: 0<y<5 and m=x+3y−2z+3. In embodiments, E is P, G is O, J is Cl, and the following mathematical formula is satisfied: 0<y<5 and m=x+5y−2z+3.

By including glass forming elements in a MACO electrolyte, the disclosed inorganic glass composite solid electrolyte has improved and long-lasting (or durable) mechanical deformability characteristics, compared with conventional MACO electrolytes. The additional glass forming elements include boron (B), phosphorus (P), silicon (Si), lanthanum (La), and cerium (Ce). These improved characteristics are due in part to the glass forming elements that provide a network by forming additional chemical bonds with adjacent atoms. This network creates or further enhances the amorphous structure of the glass. Said bonds contribute to the stability and durability of the glass by helping to prevent crystallization, meaning they prevent aging.

Further, the glass forming elements can additionally enhance the electrochemical compatibility with electrodes, compared with conventional solid electrolytes. The glass forming elements prevent the continuous decomposition of electrolytes by forming passivation layers, as the disclosed inorganic glass composite solid electrolyte is reduced. The passivation layers contain either the glass forming elements or their reduction products, which are both compatible with Li and Na metals.

In embodiments, the chalcogen element includes one of: oxygen (O); sulfur (S); or selenium (Se). In embodiments, the halide element includes one of: fluorine (F); chlorine (Cl); bromine (Br); or iodine (I). In embodiments, G denotes oxygen (O).

The one or more salts are selected from the group consisting of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂. In embodiments, the one or more salts is MN(SO₂F)₂. The listed salts passivate the interface between the LACO and Li metal. Thus, including the listed salts produces an electrolyte with an improved performance.

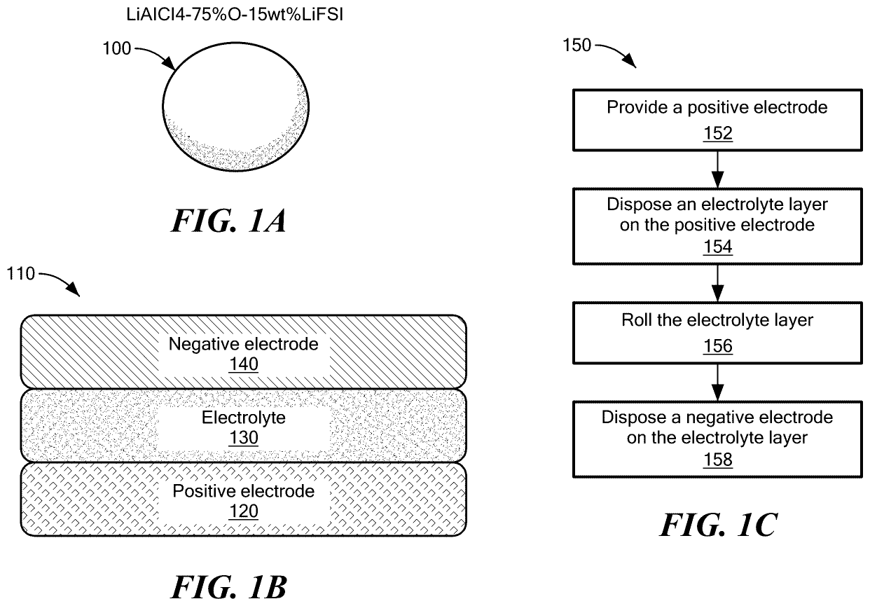

FIG. 1A is a top view of an inorganic glass composite solid electrolyte 100, illustrating a rollable LACO-FSI electrolyte (which may be referred to herein as LiAlCl_{2.5}O_{0.75} or LACO75). LACO75 refers to LiAlCl_{2.5}O_{0.75}, in which the number “75” refers to the content of oxygen (i.e., 0.75). LACO75 is manufactured by mixing LiAlCl₄ and Sb₂O₃ and heating the resulting mixture at 250° C. for 2 hours. The electrolyte 100 is made by mixing LACO and 15 wt % of LiN(SO₂F)₂ (which may be referred to herein as LiFSI) and heating the mixture for 3 mins at 160° C.

FIG. 1B is an exemplary schematic of a electrochemical cell 110 (which may be referred to herein as a battery), including the inorganic glass composite solid electrolyte. An electrolyte layer 130 is disposed on a positive electrode 120. A negative electrode 140 is disposed on the electrolyte layer 130. The electrolyte layer 130 separates the negative electrode 140 and the positive electrode 120. The electrolyte layer 130 is used to conduct ions, but not electrons.

The electrolyte layer 130 includes an inorganic glass composite solid electrolyte, such as the inorganic glass composite solid electrolyte 100. The inorganic glass composite solid electrolyte includes one or more solid electrolytes. The solid electrolyte has the chemical formula: MₓAlE_{y}G_{z}Jₘ, where M denotes Li or Na, E denotes one or more elements selected from the group consisting of boron (B), phosphorus (P), silicon (Si), lanthanum (La), or cerium (Ce), G denotes at least one chalcogen element, J denotes at least one halide element, and the following mathematical formula is satisfied: 0<x<5, 0 [symbol] y<5, 0<z<5, m=x+ny−2z+3, where n=3 when E denotes at least one element selected from the group consisting of La, Ce and B; n=4 when E denotes Si; and n=5 when E denotes P. The inorganic glass composite solid electrolyte includes one or more salts. The salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, where M is Li or Na, and where the mass ratio of the salt to the solid electrolyte is r_{w}, where 0<r_{w}<5. In embodiments, E is one element selected from the group consisting of B, P, Si, La, or Ce. In embodiments, G denotes oxygen (O).

In embodiments, the electrolyte layer 130 may include an inorganic glass composite solid electrolyte, where E is P, G is O, J is Cl, and the following mathematical formula is satisfied: 0<y<5 and m=x+5y−2z+3. In embodiments, the electrolyte layer 130 includes an inorganic glass composite solid electrolyte and the salt is MN(SO₂F)₂. In embodiments, the chalcogen element includes one of: oxygen (O); sulfur (S); or selenium (Se). In embodiments, the halide element includes one of: fluorine (F); chlorine (Cl); bromine (Br); or iodine (I).

Referring to FIG. 1C, an example of a method that may be used to form a battery is method 150. For example, method 150 may be used to form the electrochemical cell 110. The method 150 provides a positive electrode in a first block 152. In a second block 154, the method 150 disposes an electrolyte layer on the positive electrode. The electrolyte layer includes an inorganic glass composite solid electrolyte. The inorganic glass composite solid electrolyte includes one or more solid electrolytes. The solid electrolyte has the chemical formula: MₓAlE_{y}G_{z}Jₘ, where M denotes Li or Na, E denotes one or more elements selected from the group consisting of boron (B), phosphorus (P), silicon (Si), lanthanum (La), or cerium (Ce), G denotes at least one chalcogen element, J denotes at least one halide element, and the following mathematical formula is satisfied: 0<x<5, 0 [symbol] y<5, 0<z<5, m=x+ny−2z+3, where n=3 when E denotes at least one element selected from the group consisting of La, Ce and B; n=4 when E denotes Si; and n=5 when E denotes P. The inorganic glass composite solid electrolyte includes one or more salts, where the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, where M is Li or Na, and where the mass ratio of the salt to the solid electrolyte is r_{w}, where 0<r_{w}<5.

In a third block 156, the method 150 rolls the electrolyte layer. The electrolyte layer may be rolled to a desired thickness by utilizing a hot forming process. Rolling the electrolyte layer is carried out with a roller, for example a stainless steel roller.

In a fourth block 158, method 150 disposes a negative electrode on the electrolyte layer. In embodiments, a glass transition temperature (T_{g}) of the electrolyte layer is less than about room temperature (25° C.+/−2° C.).

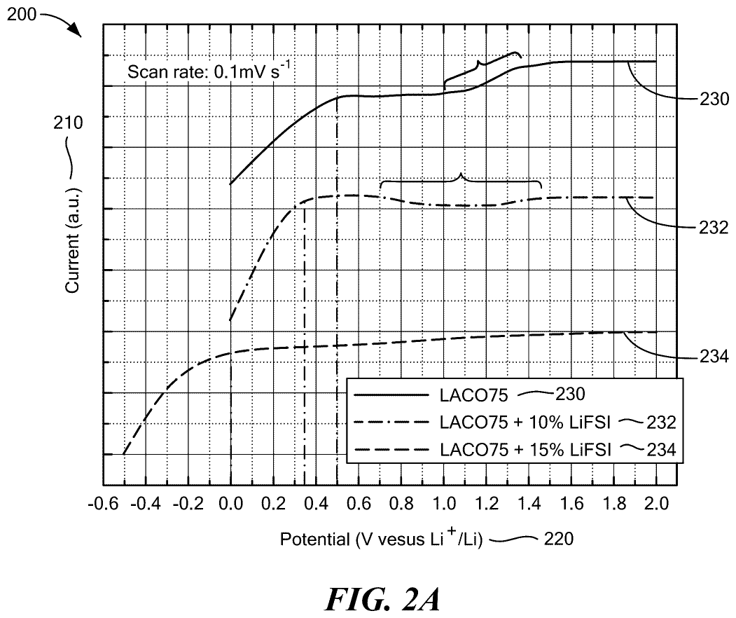

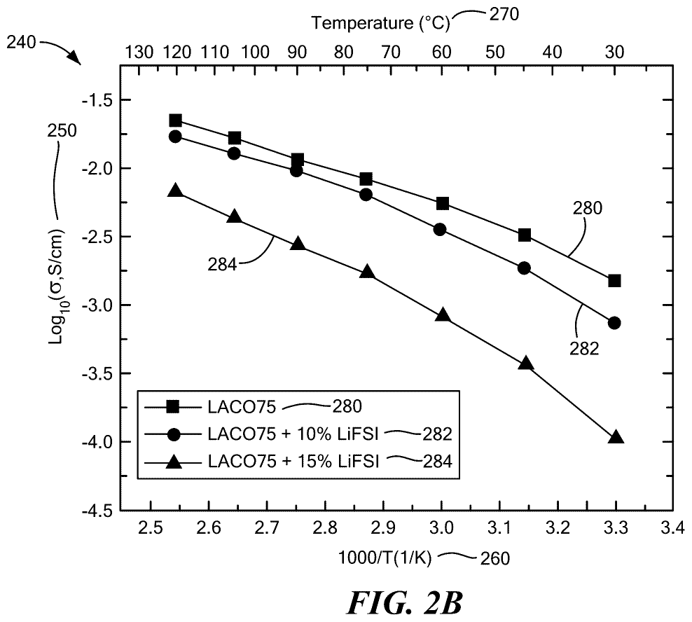

FIG. 2A is a graph 200 of the linear sweep voltammetry (LSV) test of LACO75 with different amounts of LiFSI. The graph 200 illustrates current (a.u.) 210 vs. potential (V vs. Li⁺/Li) 220, demonstrating reduction potential for LACO-LiFSI with a scan rate of 0.1 mV s⁻¹. Graph 200 illustrates the results of LACO75 in line 230, LACO75+10% LiFSI in line 232, and LACO75+15% LiFSI (which may be referred to herein as LACO75−15FSI) in line 234. LACO75+10% LiFSI or LACO75+15% LiFSI electrolytes are made by mixing LACO75 with 10 wt % or 15 wt % LiFSI and heating the resulting mixture for 3 minutes at 160° C.

In FIG. 2A, the LSV curve of LACO75, given in line 230, illustrates how the current begins to decrease when the potential sweeps below 1.5 V vs Li⁺/Li, indicating that the reduction potential of LACO75 is around 1.5 V vs Li⁺/Li. However, the curve of LACO75+10% LiFSI, given in line 232, illustrates how the current decreases a small amount when the potential is lower than 1.5V vs Li⁺/Li, indicating the reduction stability is greatly enhanced when 10 wt % LiFSI is added to LACO75.

When the content of LiFSI is further increased to 15 wt %, the current of LACO75+15% LiFSI, given in line 234, does not decrease when the potential is lower than 1.5 V vs Li⁺/Li. Further, as demonstrated by line 234, the current begins to decrease when the potential goes below 0 V. Accordingly, line 234 demonstrates how the reduction potential of LACO75+15% LiFSI decreases to 0V (i.e., the electrolyte is stable with Li metal) with the addition of 15 wt % LiFSI.

FIG. 2B is a graph 240 of Log 10 (σ, S/cm) 250 vs. 1000/T (1/K) 260 and temperature (C) 270, illustrating ionic conductivities at different temperatures. Graph 200 illustrates the results of LACO75 in line 280, LACO75+10% LiFSI in line 282, and LACO75+15% LiFSI in line 284. FIG. 2B illustrates how the ionic conductivities of LACO75+10% LiFSI and LACO75+15% LiFSI are decreased, but the ionic conductivity of LACO75+15% LiFSI at about room temperature (25° C.+/−2° C.) is still higher than 0.1 mS/cm. Accordingly, LACO75+10% LiFSI and LACO75+15% LiFSI can be used as the solid electrolyte.

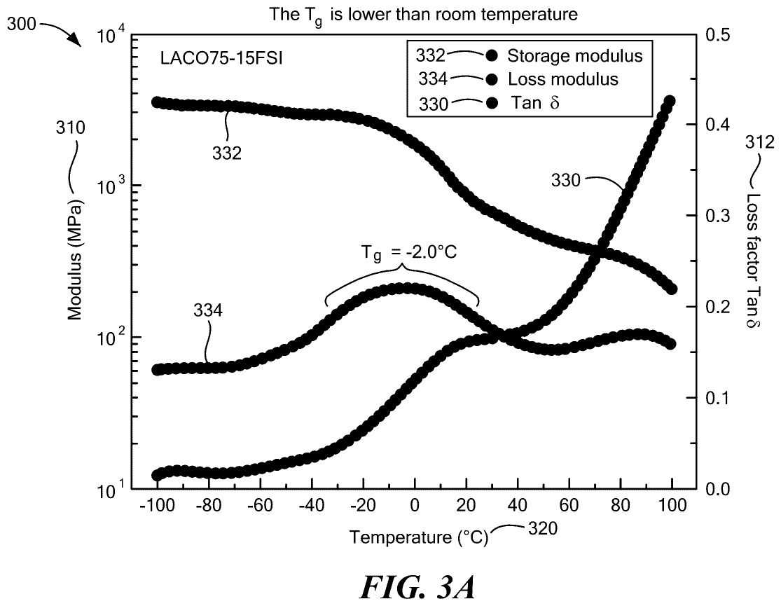

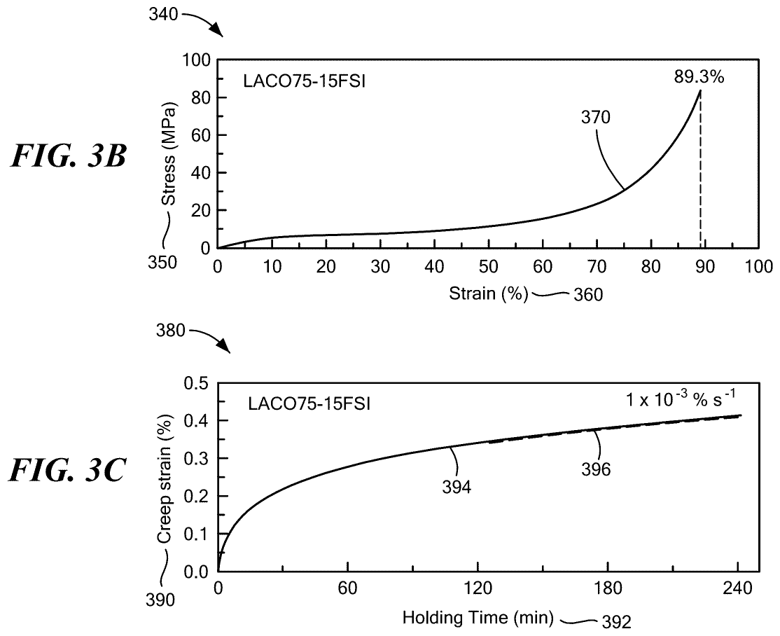

FIG. 3A is a graph 300 of temperature (° C.) 320 vs. modulus (MPa) 310 and loss factor Tan δ 312, illustrating mechanical performance. An inorganic glass composite solid electrolyte comprising LACO75+15% LiFSI was tested. The subsequent results are shown in graph 300, with dielectric loss as the loss tangent (Tan δ) in line 330, storage modulus in line 332, and loss modulus in line 334. The results illustrated in graph 300 demonstrate the T_{g}=−2.0° C. Accordingly, the T_{g} is lower than room temperature. The low T_{g} demonstrates how LACO75−15FSI maintains the LACO-like viscoelasticity at room temperature, despite of the addition of LiFSI.

FIG. 3B is a graph 340 of stress (MPa) 350 vs. strain (%) 360, illustrating mechanical performance, specifically compression. An inorganic glass composite solid electrolyte comprising LACO75−15FSI was tested, with the subsequent result illustrated in line 370. FIG. 3B illustrates how LACO75−15FSI is highly deformable at room temperature. The end of the stress-strain curve, meaning the deformation rate of 89.3%, results from reaching the maximum range of the compression device and does not represent fracture failure.

FIG. 3C is a graph 380 of creep strain (%) 390 vs. holding time (min) 392, illustrating mechanical performance, specifically creep. An inorganic glass composite solid electrolyte comprising LACO75−15FSI was tested, with the subsequent result illustrated in line 394. The line 394 illustrates how LACO75−15FSI may creep under constant stress, demonstrating the viscosity. Dashed line 396 illustrates the increase in creep strain. The creep strain increases linearly with the increase of holding time, illustrating that LACO75−15FSI has a creep rate of 1×10⁻³% s⁻¹.

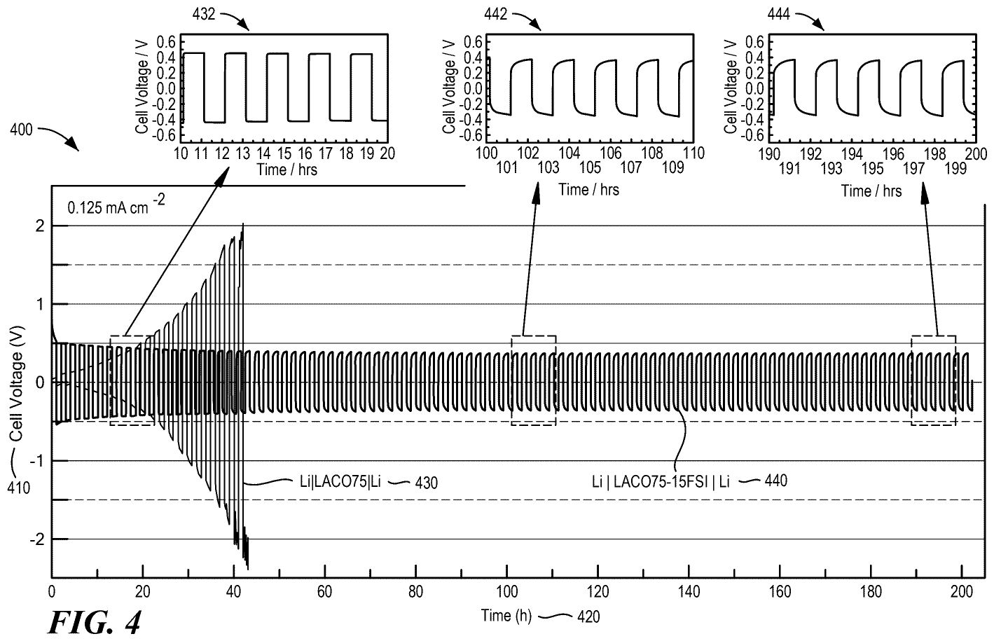

FIG. 4 is a graph 400 of cycling profiles for two cells. Graph 400 includes voltage (V) 410 vs. time (h) 420 for a first cell that includes Li/LACO75−15FSI/Li, meaning a cell with negative and positive electrodes comprising Li and an electrolyte material layer comprising LACO75−15FSI, with the results illustrated in line 440. For comparison, the results for a second cell that includes Li/LACO75/Li, meaning a cell with negative and positive electrodes comprising Li and an electrolyte material layer comprising LACO75, is illustrated in line 430. Both cells were cycled at 0.125 mA cm⁻². For reference, an expanded view of line 430 is illustrated in portion 432, and an expanded view of line 440 is illustrated in portion 442 and portion 444.

The line 430 illustrates the overpotential of the second Li/LACO75/Li cell, which increases during cycling. Meanwhile, the first Li/LACO75−15FSI/Li cell maintains stable overpotential for more than 200 hours. Accordingly, graph 400 demonstrates how LACO75−15FSI can form a stable interface with an Li metal anode and the compatibility with Li is greatly enhanced, when compared to LACO75. Additionally, the expanded views in portions 432, 442, 444 illustrate how the overpotential at different cycles is almost constant.

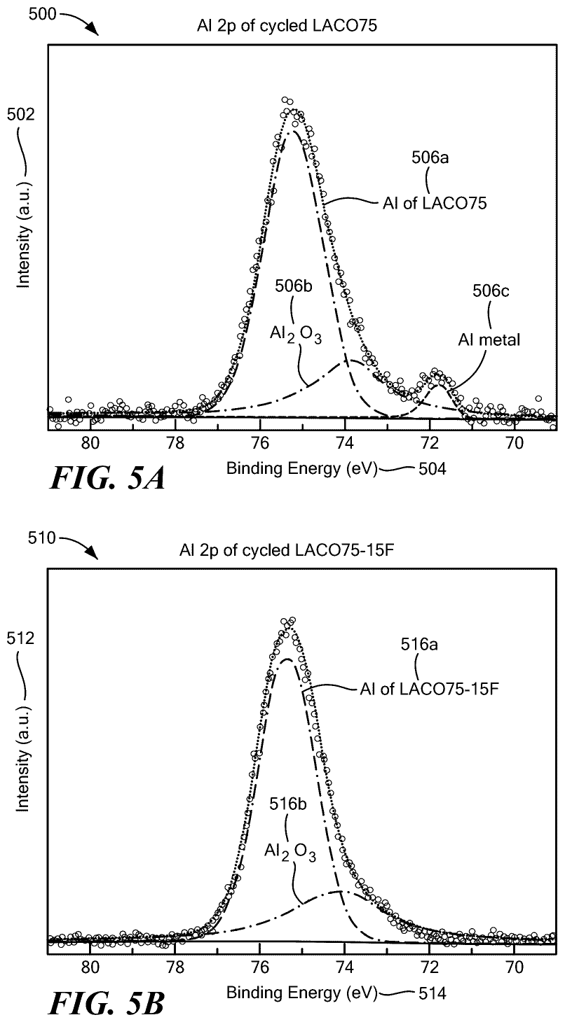

FIG. 5A is a graph 500 of intensity (a.u.) 502 vs. binding energy (eV) 504, showing the Al 2p signal of cycled LACO75 in an x-ray photoelectron spectroscopy (XPS) test. Graph 500 illustrates the results of Al of LACO75 in line 506a, Al₂O₃ in line 506b, and Al metal in line 506c. The Al of LACO75 in line 506a is the original Al signal in LACO75. The Al₂O₃ in line 506b and Al metal in line 506c are the decomposition products of LACO at the interface in contact with Li metal. Due to the electronic conductivity of the Al metal, the interface between LACO and Li is not stable.

FIG. 5B is a graph 510 of intensity (a.u.) 512 vs. binding energy (eV) 514, showing the Al 2p signal of cycled LACO75−15FSI in an XPS test. Graph 510 illustrates the results of Al of LACO75−15FSI in line 516a and Al₂O₃ in line 516b. The absence of an Al metal signal in the spectra illustrates that there is no Al metal in the decomposition products of LACO75−15FSI when in contact with Li metal. Accordingly, graph 510 demonstrates how addition of LiFSI eliminates the Al metal in the passivated interface between the LACO75−15FSI and the Li metal. Said elimination helps to build an electronically insulated (i.e., there is no electron leakage), but ionically conductive interface. Accordingly, LACO75−15FSI shows compatibility with an Li metal anode.

FIGS. 5A-5B probe the interface between LACO75−15FSI and Li metal. As illustrated in FIGS. 5A-5B, it is the addition of LiFSI that helps to eliminate the Al metal in the passivated interlayer and builds an ionically conductive and electronically insulated interface between the LACO75−15FSI and the Li metal. Due to the ionically conductive and electronically insulated interface, LACO75−15FSI is compatible with an Li metal anode.

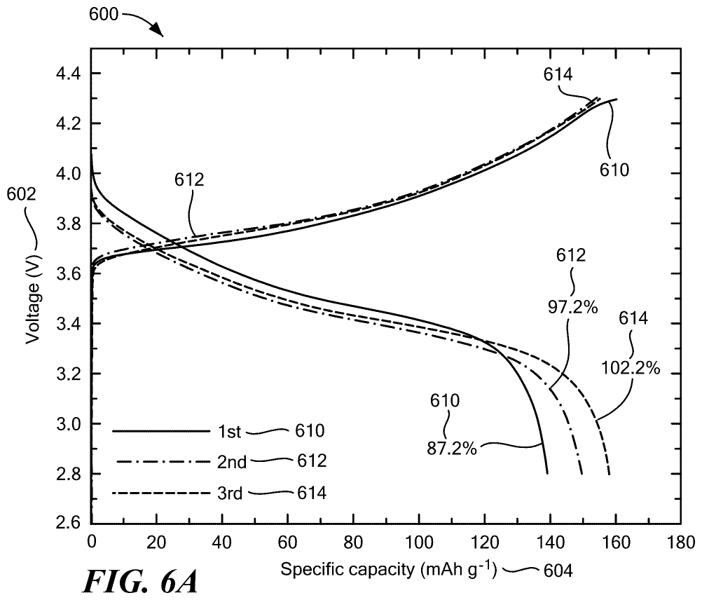

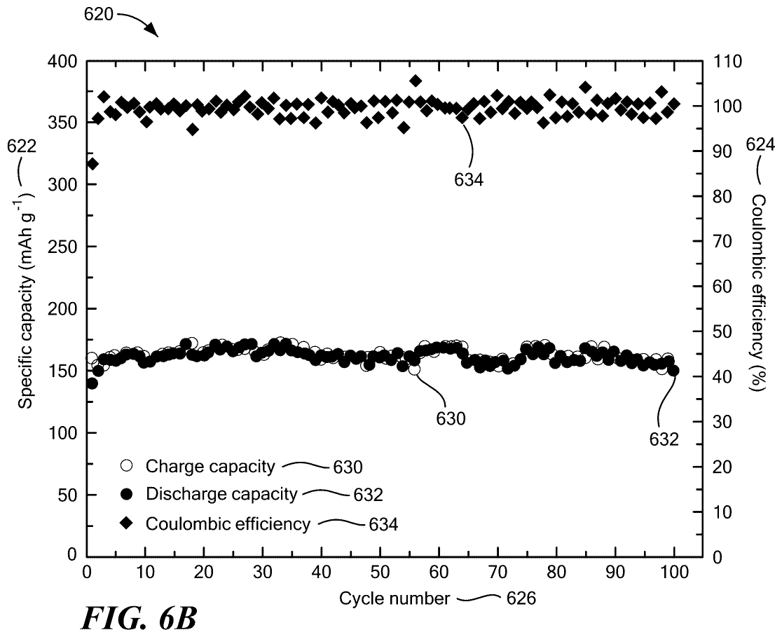

FIG. 6A is a graph 600 of voltage (V) 602 vs. specific capacity (mAh g⁻¹) 604 for a Li/LACO75−15FSI/LACO−NCM622 cell, meaning a cell with negative and positive electrodes comprising Li and LACO−NCM622 and an electrolyte material layer comprising LACO75−15FSI. The cell was cycled at room temperature (25° C.) and 0.2 C, with C referring to the C-rate, meaning the speed of charging or discharging relative to the battery's full capacity (with 1 C meaning full charge or discharge in one hour). Here, 0.2 C means the cell was charged and discharged in 5 hours. The current density is 0.15 mA/cm2.

Graph 600 illustrates cell performance, with a first cycle profile given by line 610, a second cycle given by line 612, and a third cycle given by line 614. In the first three cycles, the Coulombic efficiency increased from 87.2% to 102.2% and the discharge capacity rose from 139.4 mAh g⁻¹ to 158.3 mAh g⁻¹. The change in Coulombic efficiency and discharge capacity mainly result from the activation process at the anode interface.

FIG. 6B is a graph 620 of cycle number 626 vs. specific capacity (mAh g⁻¹) 622 and columbic efficiency (%) 624 for a Li/LACO75−15FSI/LACO−NCM622 cell, meaning a cell with negative and positive electrodes comprising Li and LACO−NCM622 and an electrolyte material layer comprising LACO75−15FSI. Graph 600 illustrates cell performance, with charge capacity given by line 630, discharge capacity given by line 632, and coulombic efficiency given by line 634. FIG. 6B shows that the cell has a notably stable charge and discharge capacity during cycling. Further, the discharge capacity reached 150.9 mAh g⁻¹ at the 100th cycle, demonstrating the notably impressive cycling stability and the compatibility of LACO75−15FSI with the Li metal anode.

There are a number of benefits resulting from the disclosed solid electrolyte composite, specifically the composite is cheaper and easier to manufacture due to the lower temperatures used and the hot forming process the composite is compatible with. Conventional processes for forming free-standing solid-state electrolyte membranes may call for sintering for crystalline ceramics or for high stacking pressure (greater than 2 MPa) to be maintained during operation. In typical sintering, to get the electrolytes to full density, high temperatures (about 1000° C.+/−10° C.) are needed and are necessary for long periods of time (about 20 hours+/−1 hour). The higher temperature and time is called for because the initial composite begins with a powder and, because the chemicals used are crystalline, it does not deform easily. Accordingly, the battery is challenging and costly to manufacture.

Alternatively, other typical semiconductor processing techniques can be used (e.g., vapor deposition, etc.), but they are challenging to scale as they can become costly and complex. In addition, the high stacking pressure (greater than 2 MPa) in operation is not practical for most application scenarios and the necessity of various fixtures to provide said pressure further reduces the energy density of the battery.

In comparison, the disclosed inorganic glass composite solid electrolyte provided in accordance with the concepts described herein, can be used in a hot forming process. The compositions provided in accordance with the concepts described herein can be rolled (with a stainless steel roller) to a desired thickness by utilizing a hot forming process. The disclosed electrolyte is compatible with the rolling process because it is soft and viscous at low temperatures (temperatures below about room temperature (25° C.+/−2° C.)) due to the low T_{g}. This means less time and lower temperatures can be used, making the electrolyte material easily manufacturable. Use of a hot forming process results in batteries that are easier and less expensive to manufacture at scale than conventional batteries manufactured using a sintering process, semiconductor processing techniques, or a process that calls for a high stacking operation pressure.

Another added benefit is the T_{g} of the electrolyte material, in some cases, can be lower than room temperature. Thus, the electrolyte is highly deformable at room temperature, enabling the ability to accommodate the strain and/or stress of electrode particles during cycling through creeping, while maintaining good adhesion force with the electrode particles. Accordingly, the stacking pressure during operation is not required in typical solid-state batteries.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” is understood to include any integer number greater than or equal to one, i.e. one, two, three, four, etc.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. An inorganic glass composite solid electrolyte, comprising:
one or more solid electrolytes, wherein the solid electrolyte has the chemical formula: MₓAlE_{y}G_{z}Jₘ, wherein
M denotes Li or Na,
E denotes one or more elements selected from the group consisting of boron (B), phosphorus (P), silicon (Si), lanthanum (La), or cerium (Ce),
G denotes at least one chalcogen element,
J denotes at least one halide element, and
the following mathematical formula is satisfied:
$$0 < x < 5 , 0 \leq y < 5 , 0 < z < 5 , m = x + ny - 2 z + 3$$
wherein n=3 when E denotes at least one element selected from the group consisting of La, Ce and B; n=4 when E denotes Si; and n=5 when E denotes P; and
one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5.

2. The inorganic glass composite solid electrolyte of claim 1, wherein E is one element selected from the group consisting of B, P, Si, La, or Ce.

3. The inorganic glass composite solid electrolyte of claim 1, wherein the chalcogen element comprises one of: oxygen (O); sulfur (S); or selenium (Se).

4. The inorganic glass composite solid electrolyte of claim 1, wherein the halide element comprises one of: fluorine (F); chlorine (Cl); bromine (Br); or iodine (I).

5. The inorganic glass composite solid electrolyte of claim 1, wherein E is B, P, or Si and the following mathematical formula is satisfied: 0<y<5.

6. The inorganic glass composite solid electrolyte of claim 1, wherein E is La or Ce and the following mathematical formula is satisfied: 0<y<5 and m=x+3y−2z+3.

7. The inorganic glass composite solid electrolyte of claim 1, wherein G denotes oxygen (O).

8. The inorganic glass composite solid electrolyte of claim 1, wherein E is P, G is O, J is Cl, and the following mathematical formula is satisfied: 0<y<5 and m=x+5y−2z+3.

9. The inorganic glass composite solid electrolyte of claim 1, wherein the one or more salts is MN(SO₂F)₂.

10. A battery, comprising:
a positive electrode;
an electrolyte layer disposed on the positive electrode, the electrolyte layer comprising an inorganic glass composite solid electrolyte, comprising one or more solid electrolytes, wherein the solid electrolyte has the chemical formula:
MₓAlE_{y}G_{z}Jₘ, wherein
M denotes Li or Na,
E denotes one or more elements selected from the group consisting of boron (B), phosphorus (P), silicon (Si), lanthanum (La), or cerium (Ce),
G denotes at least one chalcogen element,
J denotes at least one halide element, and
the following mathematical formula is satisfied:
$$0 < x < 5 , 0 \leq y < 5 , 0 < z < 5 , m = x + ny - 2 z + 3$$
wherein n=3 when E denotes at least one element selected from the group consisting of La, Ce and B; n=4 when E denotes Si; and n=5 when E denotes P; and
one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5; and
a negative electrode disposed on the electrolyte layer.

11. The battery of claim 10, wherein E is one element selected from the group consisting of B, P, Si, La, or Ce.

12. The battery of claim 10, wherein G denotes oxygen (O).

13. The battery of claim 10, wherein E is P, G is O, J is Cl, and the following mathematical formula is satisfied: 0<y<5 and m=x+5y−2z+3.

14. The battery of claim 10, wherein the one or more salts is MN(SO₂F)₂.

15. The battery of claim 10, wherein the chalcogen element comprises one of: oxygen (O); sulfur (S); or selenium (Se).

16. The battery of claim 10, wherein the halide element comprises one of: fluorine (F); chlorine (Cl); bromine (Br); or iodine (I).

17. A method for forming a battery, comprising:
providing a positive electrode;
disposing an electrolyte layer on the positive electrode, wherein the electrolyte layer comprises an inorganic glass composite solid electrolyte, comprising: one or more solid electrolytes, wherein the solid electrolyte has the chemical formula: MₓAlE_{y}G_{z}Jₘ
wherein M denotes Li or Na,
E denotes one or more elements selected from the group consisting of boron (B), phosphorus (P), silicon (Si), lanthanum (La), or cerium (Ce),
G denotes at least one chalcogen element,
J denotes at least one halide element, and
the following mathematical formula is satisfied:
0<x≤5, 0<y<5, 0<z<5, m=x+ny−2z+3, wherein n=3 when E denotes at least one element selected from the group consisting of La, Ce and B; n=4 when E denotes Si; and n=5 when E denotes P; and
one or more salts, wherein the salts are selected from one or more of MN(SO₂F)₂, MNO₃, MPF₆, MClO₄, MBF₄, MSO₃CF₃, MN(SO₂CF₃)₂, MC(SO₂CF₃)₃, MBC₄O₈, and MBC₂O₄F₂, wherein M is Li or Na, and wherein the mass ratio of the salt to the solid electrolyte is r_{w}, wherein 0<r_{w}<5;
rolling the electrolyte layer to a desired thickness by utilizing a hot forming process; and
disposing a negative electrode on the electrolyte layer.

18. The method of claim 17, wherein rolling the electrolyte layer is carried out with a roller.

19. The method of claim 17, wherein a glass transition temperature (T_{g}) of the electrolyte layer is less than room temperature.

20. The method of claim 17, wherein E is one element selected from the group consisting of B, P, Si, La, or Ce.
